(19) United States
(12) Patent Application Publication
(10) Pub. No.: US 2017/0205967 A1
(43) Pub. Date: Jul. 20, 2017

(54) DISPLAY AND INTERACTION METHOD IN A USER INTERFACE

(71) Applicant: Swirl Design (Pty) Ltd, Stellenbosch (ZA)

(72) Inventor: Hendrik Frans Verwoerd Boshoff, Stellenbosch (ZA)

(73) Assignee: Swirl Design (Pty) Ltd, Stellenbosch (ZA)

(21) Appl. No.: 15/327,924

(22) PCT Filed: Jul. 30, 2015
(86) PCT No.: PCT/IB2015/055773

§ 371 Date: Jan. 20, 2017

(30) Foreign Application Priority Data
Aug. 4, 2014 (ZA) 2014/05729
Jun. 22, 2015 (ZA) 2015/04463

(51) Int. Cl. G06F 3/0482; G06F 3/0485; G06F 3/0488; G06F 3/0481

(52) U.S. Cl. CPC G06F 3/0482; G06F 3/04817; G06F 3/0485; G06F 3/0488; G06F 2203/04806

(57) ABSTRACT

The invention provides a system and method for display and interaction in a user interface. A display region is provided for displaying a subset of a plurality of interactive items on a display curve. A touch-sensitive control region is provided for hosting a control curve positioned separately from the display curve, tracking the position and/or movement of a pointer in the control region, and, based on the position and/or movement of the pointer in the control region at a given time, updating the subset of the plurality of interactive items on the display curve.

### CROSS-REFERENCES TO RELATED APPLICATIONS

This application claims priority to South African provisional patent application No. 2014/05729 filed on 4 Aug. 2014 and South African provisional patent application No. 2015/04463 filed on 22 Jun. 2015, both of which are incorporated by reference herein.

### FIELD OF THE INVENTION

This invention relates to display and interaction in a user interface. More particularly, the invention relates to a method of displaying and selecting an interactive item from a plurality of interactive items.

### BACKGROUND TO THE INVENTION

In many electronic devices, such as mobile phones, tablet computers, personal computers, televisions, or the like, a user interface is provided to receive user input and control a display of the electronic device so as to allow a user to interact with the electronic device.

Typically, a plurality of interactive items are available to the user and the user may be required to operate a pointer to select one of the interactive items. The interactive item may, for example, be an icon, a menu item, an application, an image or video, a button or any other item positioned in a display region of the electronic device. Throughout this specification, the term “interactive item” should be broadly interpreted and is used to refer to any target provided by a user interface which may or may not be displayed at that time and which a user may wish to select.

In some cases, the electronic device includes a touch-sensitive control region, which may be or form part of a touch-sensitive display. Examples of such electronic devices are mobile phones and tablet computers having touch-sensitive displays. The pointer used to select interactive items may be the position, movement and/or touch of a finger or fingers of the user, or of any other suitable pointing tool in the control region.

A number of methods have been developed to allow the user of an electronic device having a touch-sensitive display to select one of a relatively large number of interactive items. Typically, the user is required to perform actions such as swiping or pinching in order to reach a desired interactive item, and then perform a selection action to select the interactive item. For example, a large number of photos, videos or contacts may be available for selection and a pointing finger may be used to navigate to and select a desired item by touching it.

A problem associated with certain user interface implementations is that it may be difficult or cumbersome for a user to reach a desired interactive item using only one hand. For example, when searching through a relatively large number of photos or contacts on a mobile phone, some icons on the screen, typically on a top left-hand corner, may be difficult for the user to reach with a thumb while holding the mobile phone in the palm of a right hand.

In an attempt to alleviate this problem, Patent Cooperation Treaty (PCT) patent publication number WO2013176472A1 proposes determining a user-touchable area and rearranging interactive items in the display of an electronic device to conform to the user-touchable area, such that the selectable interactive items are substantially within reach when the user is using only one hand. Such an implementation may, however, make it difficult to effectively utilise the space provided by the display of the electronic device.

Furthermore, these and other known methods and user interfaces may lead to a problem referred to as finger occlusion. The term “finger occlusion” is used to refer to cases where a pointing finger occludes one or more interactive items while the user is searching for a desired interactive item. This may also make the selection of a desired interactive item from a plurality of interactive items a difficult or cumbersome task.

The present invention aims to alleviate these and other problems, at least to some extent.

### SUMMARY OF THE INVENTION

In accordance with the invention there is provided a display and interaction method in a user interface, comprising:
providing a display region for displaying a subset of a plurality of interactive items on a display curve;
providing a touch-sensitive control region for hosting a control curve positioned separately from the display curve;
tracking the position and/or movement of a pointer in the control region; and
based on the position and/or movement of the pointer in the control region at a given time, updating the subset of the plurality of interactive items on the display curve.

A further feature provides for the method to include the step of projecting the position and/or movement of the pointer in the control region onto the control curve such that the position and/or movement in the control region is interpreted as the position and/or movement on the control curve.

Still further features provide for the method to include the step of: responsive to detecting a selection action performed on any one of the interactive items on the display curve, selecting the interactive item. In at least one embodiment of the invention, the display curve is provided in a touch-sensitive region of the user interface, and the selection action includes the pointer being placed on and removed from the desired interactive item on the display curve.

Yet further features provide for the method to include the steps of: providing a primary selection region on the display curve; responsive to detecting a predefined change in the position and/or movement of the pointer on the control region, updating an interactive item within the primary selection region; and, responsive to detecting a selecting action for the primary selection region performed by the pointer, selecting the interactive item within the primary selection region.

Further features provide for the selection action for the primary selection region to include removal of the pointer from contacting the touch-sensitive control region; preferably in response to a selection indicator appearing at or near an interactive item within the control region. The selection indicator may be configured to appear at or near the interactive item currently within the primary selection region when the pointer has remained stationary for a predetermined amount of time, preferably when the pointer has remained stationary for a predetermined amount of time in a specific region in the control region, or when the interactive item in the primary selection region has remained in the primary selection region for a predetermined period of time.

Still further features provide for the display curve to be positioned separately from the control curve on a single touch-sensitive display of an electronic device; alternatively, for the control curve and the display curve to be provided on separate components of a single electronic device; alternatively, for the control curve and the display curve to be provided on physically separate electronic devices.

The subset of the plurality of interactive items on the display curve may be dynamically updated by contacting the control region with the pointer and moving the pointer along the control region so as to cause corresponding movement along the display curve, the movement constituting browsing through the interactive items.

Yet further features provide for the method to include displaying some of the interactive items in different sizes and/or at least partially overlapping some of the interactive items; for the item within the primary selection region to be larger than the other interactive items on the display curve, overlapping the other interactive items and/or visually indicated as the item within the primary selection region; and for the interactive items to be sized and/or and at least partially overlapped based on their arrangement in relation to the item within the primary selection region. In at least one embodiment, the interactive items progressively reduce in size from the primary selection region towards the ends of the display curve so that the ends of the display curve form vanishing points. The size and/or position of the interactive items may be dynamically updated as the pointer is moved along the control curve.

According to one aspect, the item within the primary selection region is shown in a focus area. The focus area may be in a substantially fixed position in the display region and updating the subset of a plurality of interactive items on the display curve may include moving a different interactive item into the focus area such that it falls within the primary selection area.

According to a further aspect, the control curve may be provided in a thumb zone of the touch-sensitive control region, which may be a sector of the control region at a corner of the electronic device closest to a user's thumb when the electronic device is held in a palm of the user's hand.

According to a yet further aspect, the control region is provided in the thumb zone of a touch-sensitive display of an electronic device, and the display curve is provided as a substantially space-filling curve on the same display such that the interactive items displayed on the display curve substantially fill a remainder of the touch-sensitive display.

The method may also include the step of: providing a continuous subset updating zone at one or both ends of the control curve, with movement of the pointer into the continuous subset updating zone causing the plurality of interactive items on the display curve to be updated, and preferably to be updated by moving interactive items along the display curve such that an interactive item is added to one end of the display curve at substantially the same time that another interactive item is removed at an opposite end of the display curve.

In at least one embodiment, the continuous subset updating zone may be configured such that an initial updating rate matches a final browsing rate at the time of the pointer entering the continuous subset updating zone; and so that movement of the pointer in a predetermined direction within the continuous subset updating zone alters the updating rate and/or updating direction. The continuous subset updating zone may also be entered when the pointer is placed directly in the continuous subset updating zone, without browsing having occurred first.

The method may also include the step of, responsive to detecting a predefined change in position and/or movement of the pointer in relation to the control curve, dynamically updating a zoom level of at least one of the interactive items on the display curve.

The method may further include the step of, in the display region, displaying properties of the interactive item in the primary selection region. The properties may be any one or more of a creation date, a title, a description, or the like.

The method may still further include the step of providing, as part of the list of interactive items, a selectable icon allowing an application to be launched or an action to be performed, for example a camera application or a delete action.

The invention extends to an electronic device having a user interface, the user interface comprising:
a display component for displaying a plurality of interactive items on a display curve;
a touch-sensitive control component for hosting a control curve positioned separately from the display curve;
a tracking component for tracking the position and/or movement of a pointer in the control region; and
an updating component for, responsive to detecting a position and/or movement of the pointer along the control curve, updating the interactive items on the display curve.

Further features provide for the user interface to include a projecting component for projecting the position and/or movement of the pointer in the control region onto the control curve such that the position and/or movement in the control region is interpreted as the position and/or movement along the control curve.

Still further features provide for the user interface to include a selecting component for, responsive to detecting a selecting action performed on any one of the interactive items on the display curve, selecting the interactive item.

Further features provide for the user interface to include a continuous subset updating component for providing a continuous subset updating zone in the touch-sensitive control region wherein movement of the pointer into the continuous subset updating zone causes the plurality of interactive items on the display curve to be updated, and preferably to be updated by moving interactive items along the display curve such that an interactive item is added to one end of the display curve at substantially the same time that another interactive item is removed at an opposite end of the display.

Still further features provide for the user interface to include a zooming component for, responsive to detecting a predefined change in position and/or movement of the pointer in relation to the control curve, dynamically updating the zoom level of at least one of the interactive items on the display curve.

### BRIEF DESCRIPTION OF THE DRAWINGS

The invention will now be described, by way of example only, with reference to the accompanying representations in which:

FIG. 1 is a block diagram illustrating logical components of an embodiment of a user interface according to the invention;

FIG. 2 is a block diagram illustrating steps performed in a display and interaction method in a user interface according to the invention;

FIGS. 3A to 3I illustrate an exemplary implementation of a display and interaction method in a user interface according to the invention;

FIG. 4 illustrates an alternative implementation of a display and interaction method in a user interface according to the invention; and

FIG. 5 illustrates a further implementation of a display and interaction method in a user interface according to the invention.

### DETAILED DESCRIPTION WITH REFERENCE TO THE DRAWINGS

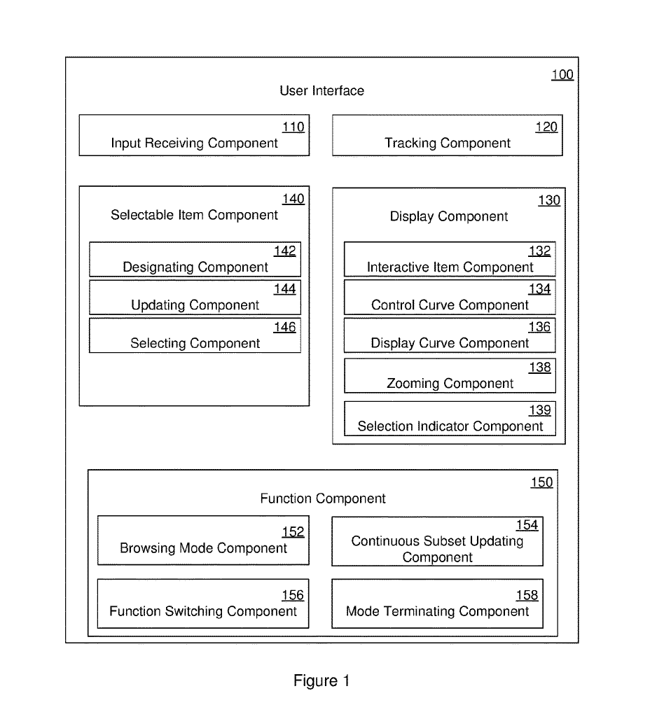

Embodiments of the invention provide a user interface usable to display and select an interactive item from a plurality of interactive items. Logical components of an embodiment of a user interface (100) according to the invention are illustrated in FIG. 1.

The user interface (100) may be the user interface of an electronic device such as a mobile phone, tablet computer, personal computer, television, or the like. The user interface (100) may include an input receiving component (110) for receiving user input. User input may be received by way of a pointer of a user contacting a touch-sensitive control region such as a touch-sensitive display of the electronic device. Throughout this specification, “movement” of the pointer should be broadly interpreted and may include dragging the pointer along a touch-sensitive region without lifting it therefrom, or sliding the pointer along a touch-sensitive region.

The user interface (100) includes a tracking component (120) for tracking the position and/or movement of the pointer in the touch-sensitive control region, and a display component (130) for displaying a plurality of interactive items on a display curve provided in a display region of the user interface (100).

In embodiments of the invention, the display curve is mapped to a control curve which is provided in the touch-sensitive control region of the user interface (100) and is positioned separately from the display curve. This aspect will be described in greater detail in what follows.

The display component (130) may include subcomponents such as an interactive item component (132) for displaying the interactive items, a control curve component (134) for providing the control curve, and a display curve component (136) for providing the display curve which is mapped to the control curve.

The display component (130) may also include a zooming component (138) for, responsive to detecting a predefined change in position and/or movement of the pointer in relation to the control curve, dynamically updating a zoom level of at least one of the interactive items on the display curve. The zooming component may be configured to change the zoom level of all the interactive items on the display curve. Additionally, a selection indicator component (139) for indicating which interactive item is within a primary selection region may be provided.

The user interface (100) may further include a selectable item component (140), which may have a designating component (142) for, based on the position and/or movement of the pointer in the control region at a given time, designating one of the interactive items in the primary selection region on the display curve as a primary selectable item, and an updating component (144) for, responsive to detecting a predefined change in position and/or movement of the pointer along the control curve, updating the primary selectable item on the display curve. The designating component (142) may also include a selecting component (146) for, responsive to detecting a selecting action performed by the pointer on any one of the interactive items on the display curve, selecting that interactive item. Additionally, the designating component (142) may be configured to, in response to a primary selection action being performed, selecting the interactive item currently in the primary selection region.

In some embodiments, and as shown in FIG. 1, the user interface (100) may also include a function component (150). The function component (150) may include a browsing mode component (152) for providing a browsing mode wherein the primary selectable item may be updated or selected, and a continuous subset updating component (154) for providing a continuous subset updating mode wherein interactive items appearing on the display curve may be updated.

The function component (150) of the user interface (100) may also include a function switching component (156) for switching between the browsing mode and the continuous subset updating mode.

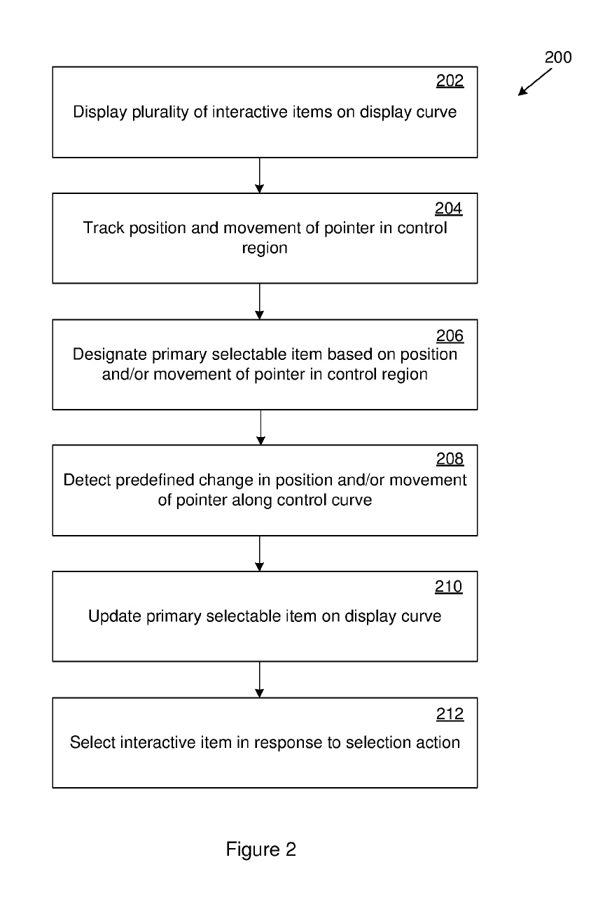

A user interface such as the user interface (100) described with reference to FIG. 1 may be used to perform a display and interaction method wherein interactive items are displayed in a display region and wherein one or more of the interactive items may be selected by a user. The block diagram (200) of FIG. 2 sets out steps which may be performed in such a display and interaction method.

At a first stage (202), a plurality of interactive items are displayed on a display curve provided in a display region of the user interface. As stated above, the display curve is mapped to a control curve which is provided in a touch-sensitive control region of the user interface and is positioned separately from the display curve. The interactive items may be displayed on a touch-sensitive display of an electronic device.

The tracking component (120) may, at a next stage (204), be used to track the position and/or movement of a pointer in the control region. In some embodiments, the control region and display region are provided in separate regions of a single touch-sensitive display of an electronic device so as to separate the control curve and the display curve.

At a next stage (206), based on the position and/or movement of the pointer in the control region at a given time, the designating component (142) may be used to designate one of the interactive items on the display curve as a primary selectable item.

At a next stage (208), the user interface (100) detects a predefined change in position and/or movement of the pointer along the control curve. In response to detecting the change in position and/or movement along the control curve, and the updating component (144) may be used to update the primary selectable item in the primary selection region on the display curve at a next stage (210).

Responsive to detecting a selecting action performed by the pointer on any of the interactive items appearing on the display curve selecting an interactive item occurs at a next stage (212). It should be noted that the selection action may be a primary selection action, in which interactive item is selected in the primary selection region.

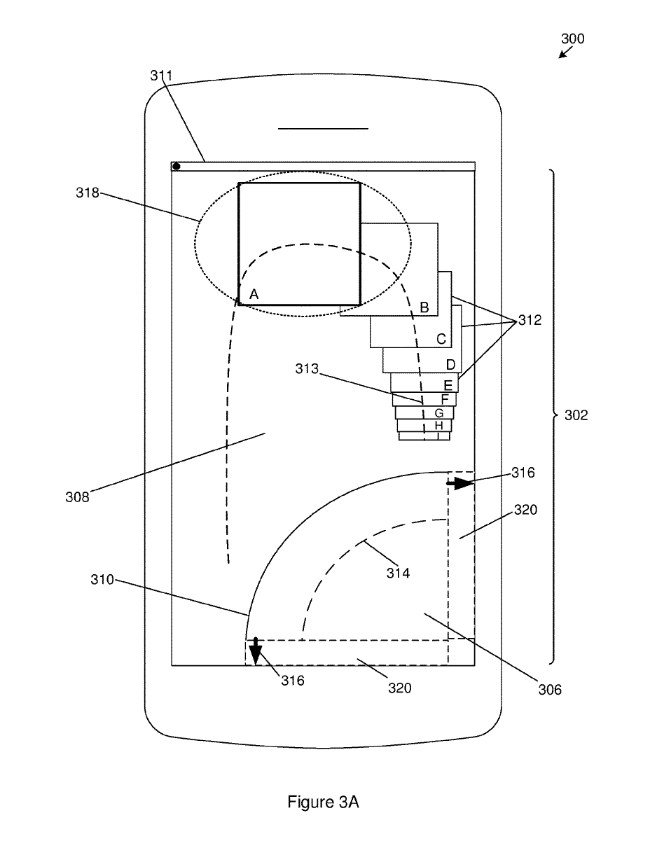

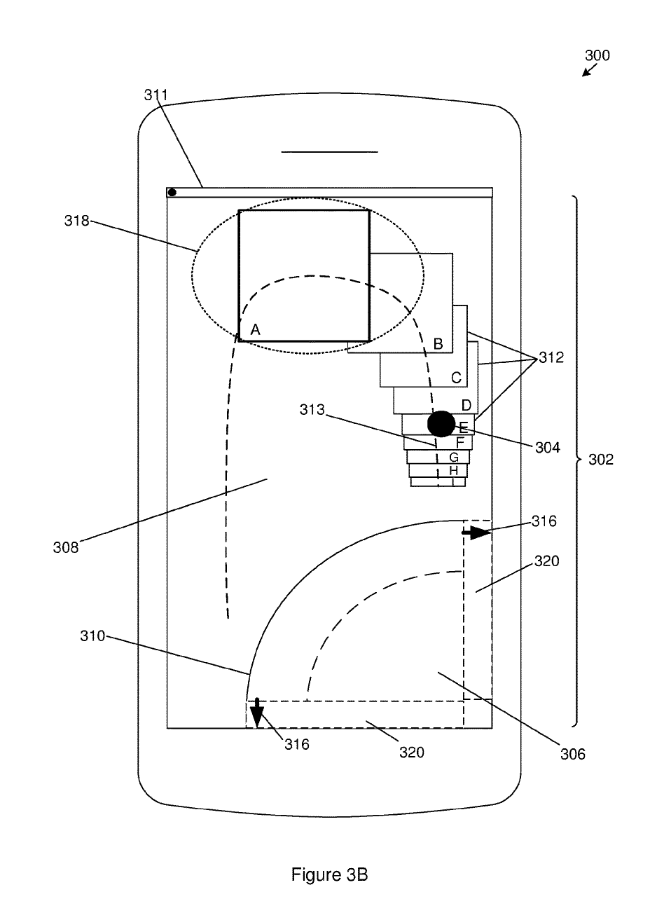

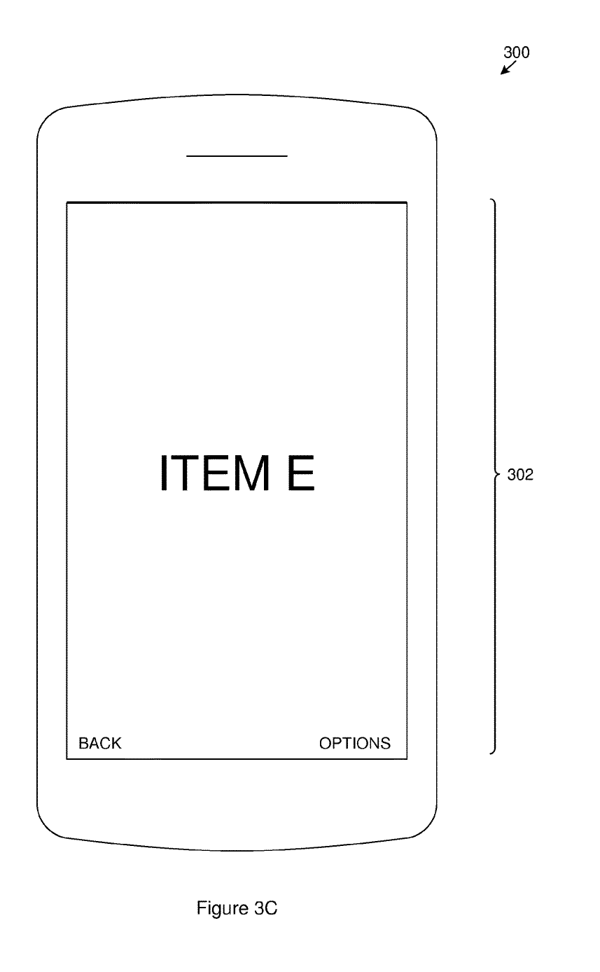

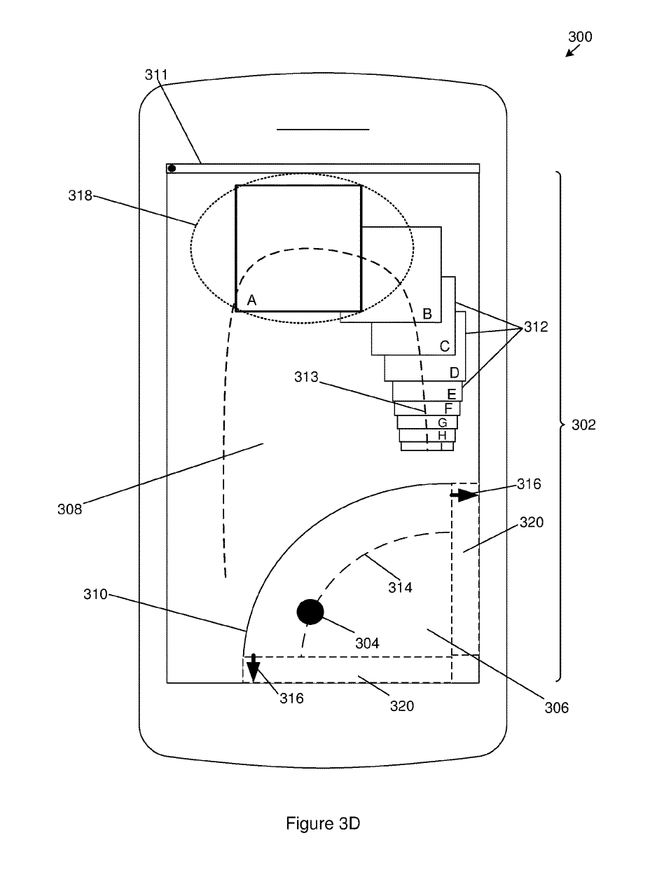

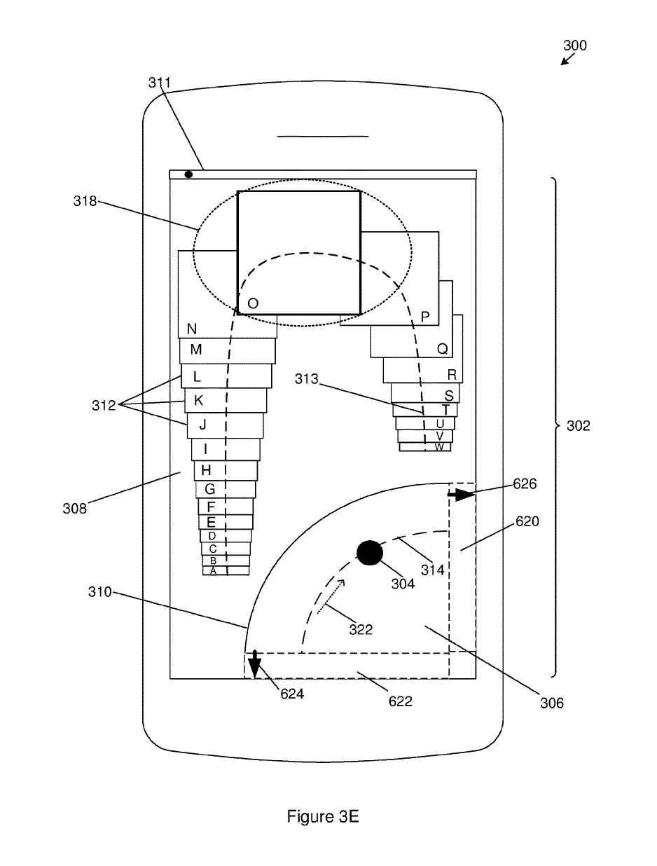

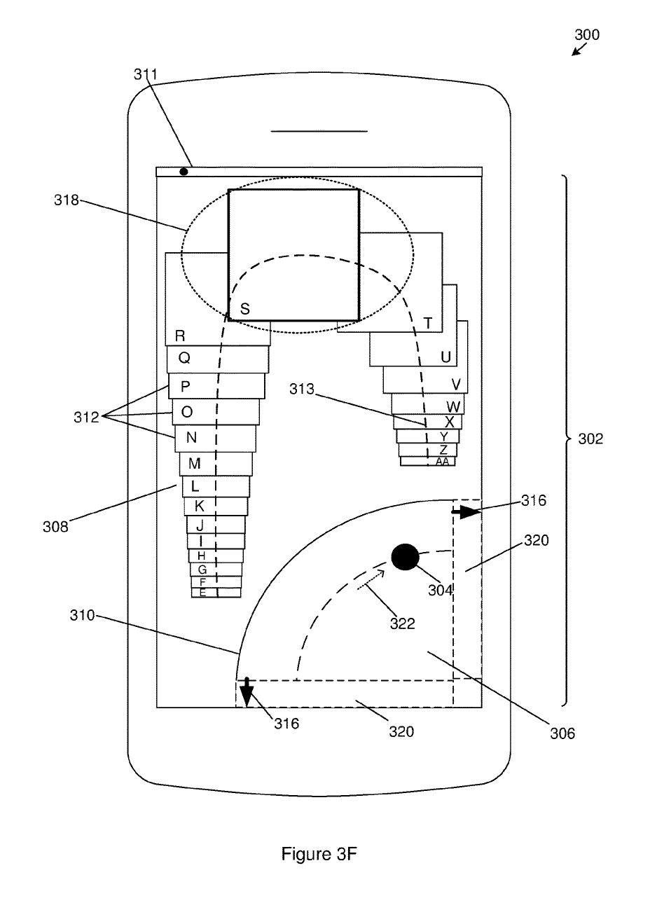

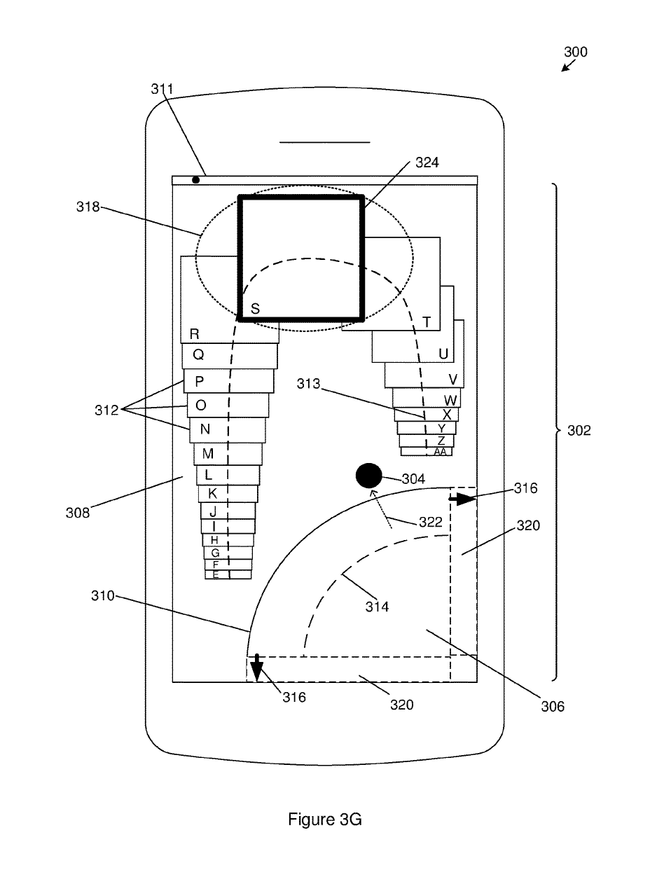

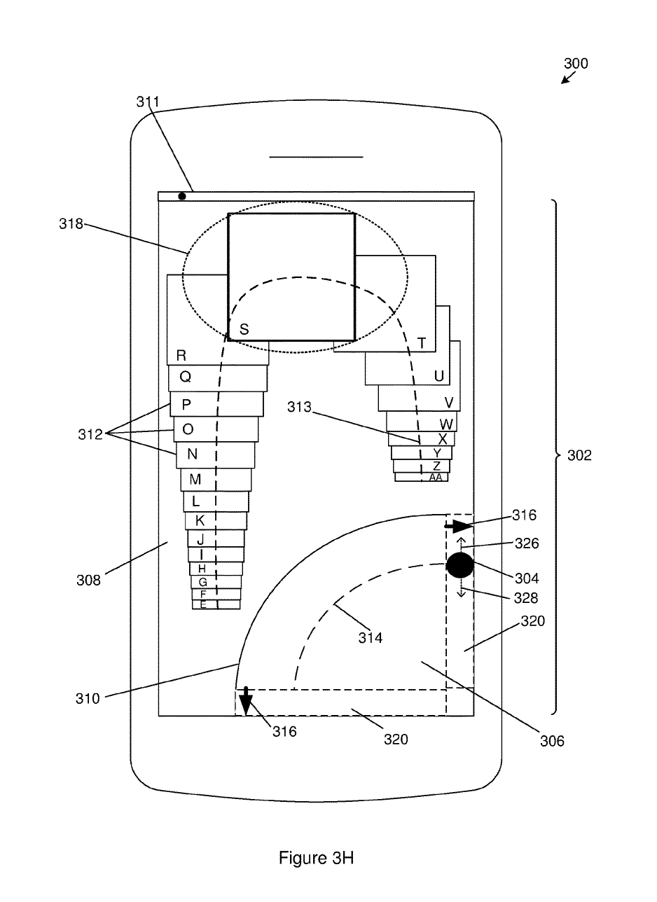

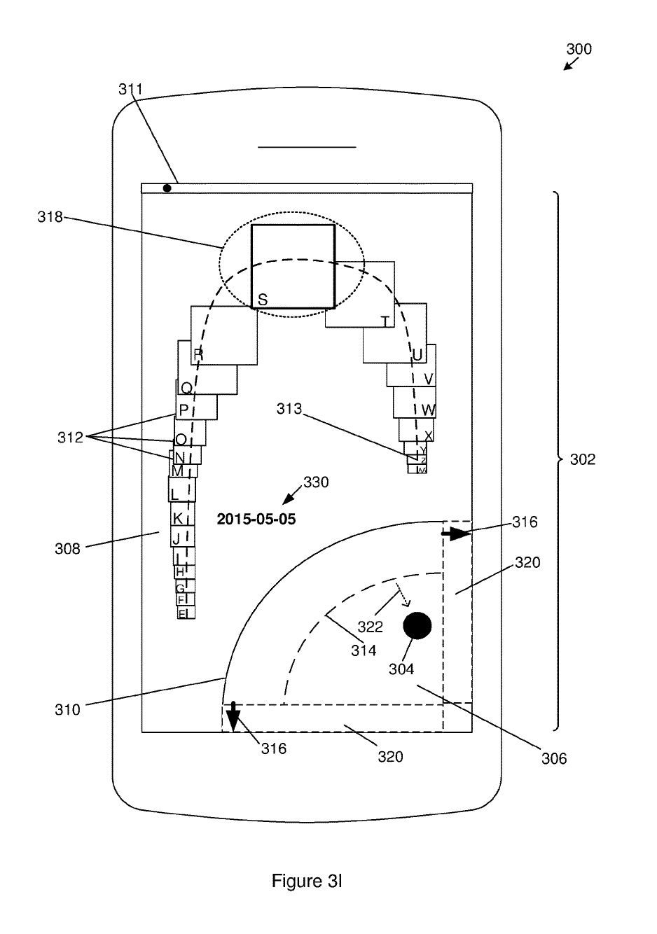

An exemplary implementation of a display and interaction method in a user interface is illustrated in FIGS. 3A to 3I. In this embodiment, the electronic device having the user interface is a mobile phone (300) with a touch-sensitive display (302). The pointer (304), which is shown as a large black dot for illustrative purposes, may be the position, movement and/or touch of a finger or fingers of a user, or of any other suitable pointing tool or pointer.

The control region (306) and display region (308) are initially separated from each other in this embodiment. A representation indicating the initial control region (306) is provided in a lower region of the display (302), and the display region (308) is provided in a remainder of the display (302). A line (310) between the initial control region (306) and the display region (308) illustrates a boundary between an initial location of the control region (306), and the display region (308).

A plurality of interactive items (312) are displayed on a display curve (313) in the display region (308). The display curve (313) is shown as a broken line. The display curve (313) is associated with a control curve (314) in the control region (306), and the arrangement of the interactive items (312) in FIG. 3A illustrates the shape of the display curve (313). Directional arrows (316) are provided at ends of the control curve to indicate the direction of movement on the control curve that will cause corresponding movement of the interactive items on the display curve, although it will of course be appreciated that these arrows could be placed in any other suitable position or could be done away with to simply the interface. At each end of the control curve (314), and extending substantially parallel to the sides of the display (302), there is a continuous subset updating zone (320).

In this embodiment, the control curve (314) is curvilinear, as indicated by the broken line (314). The user interface is configured such that the position and/or movement of the pointer (304) in the control region (306) is projected onto the control curve (314) such that movement in the control region (306) is interpreted as and causes corresponding movement along the control curve. The control region (306) may be provided to make it easier for a user to move the pointer (304) along the control curve (314), as derivation from the substantially one-dimensional control curve (314) will still be interpreted as though the pointer (304) is positioned in the control curve (314) as long as it remains within the bounds of the control region (306).

Throughout this specification, the phrase “movement along the control curve” thus includes movement in the control region (306) which is projected onto a predefined point or range in the control curve (314).

The display curve may be a substantially space-filling curve in the display (302), its curve selected so as to substantially fill the remainder of the display (302) which is not taken up by the initial control region (306).

As shown, the control curve (314) is located in a thumb zone of the touch-sensitive control region (306). The thumb zone is a sector of the control region (306) at a corner of the electronic device closest to a user's thumb when the electronic device is held in a palm of the user's hand. Although the thumb zone shown in the present embodiment is located to facilitate operation via a right thumb of a user, typically when the mobile phone (300) is held with a right hand, it may easily be positioned for use with a left thumb of a user when the mobile phone is held with a left hand.

In some embodiments, the user may be permitted to select a “right hand mode” or a “left hand mode”, with the thumb zone being positioned accordingly. In additional embodiments, the mobile phone (300) may be configured to detect with which hand it is being held or operated and adjust the thumb zone accordingly.

Based on the position and/or movement of the pointer in the control region (306) at a given time, one of the interactive items (312) may be designated as a primary selectable item. In the embodiment shown in FIGS. 3A to D and 3F to 3I, the primary selectable item is shown in an elliptical focus area (318). In this example, the focus area is provided in an upper region of the display (312) and remains in a substantially fixed position in the display region (308). Updating of the primary selectable item on the display curve (313) is carried out by moving a different interactive item into the focus area (318) as the pointer (304) is moved along the control curve (314), such that a different interactive item becomes designated as the primary selectable item.

The primary selectable item may be dynamically updated by contacting the control region (306) and therefore the control curve (314) with the pointer (304) and moving the pointer along the control curve (314). In this embodiment, a predefined movement of the pointer along the control curve causes the primary interactive item to update. Simultaneously, the subset of interactive items shown on the display curve is updated so that an interactive item at substantially the same position within the range of interactive items appearing on the display curve appears in and is designated as the primary selectable item.

If a primary selection action is performed, the item currently designated as the primary selectable item is selected. However, all of the interactive items on the display curve are selectable by performing a standard selection action on them. This will typically be the pointer being placed on, and removed from, the interactive item on the display curve that the user wishes to select. The primary selection item, on the other hand, may involve the pointer being removed from the display when a selection indicator, for example a frame, appears at the primary selectable item. Typically, the selection indicator will be configured to only appear when the pointer is located in, or remains stationary in, a specific region on the control region. In the present embodiment, the selection indicator is configured to appear when the pointer is moved from the initial control region, over and beyond the line (310) separating the initial control region and the display region. Alternatively, the selection indicator may be configured to appear in response to the interactive item in the primary selection region having remained in the primary selection region for a predetermined period of time, for example when the interactive item in the primary selection region is changing slowly.

Turning to the exemplary implementation in FIGS. 3A to 3I, a user may wish to select an interactive item from a plurality of interactive items. In FIG. 3A, a number of interactive items are displayed on the display curve after initiation of the method. The interactive items (312) may, for example, be photos or contacts stored on the mobile phone (300).

In this embodiment, the interactive items (312) are displayed in different sizes and partially overlap each other. The primary selectable item is larger than the other interactive items and overlaps some of the other interactive items. The interactive items (312) are, in this embodiment, sized and at least partially overlapped based on their arrangement in relation to the primary currently selectable item. The interactive items closer to the primary currently selectable item are larger than the interactive items positioned further away from the primary currently selectable item.

As the total number of interactive items stored on the mobile phone is typically much more that can be displayed on the display curve at any given time, only a subset of the total interactive items are displayed on the display curve at a time. When the method is initiated, the initial subset displayed on the display curve may be the subset displayed at a previous time that the method was terminated, may be the latest subset according to a standard sorting method, for example by date, or the like. In the present embodiment, the subset is arranged by date, with the latest added item to the complete list appears as the primary selectable item, and the rest of the items appearing in chronological order afterwards.

A sequence bar (311) is provided to indicate where in the complete list of interactive items the primary selectable item falls.

All of the interactive items on the display curve are selectable, and any of them may be selected by placing the pointer on the intended item, and removing it therefrom. FIG. 3B shows the pointer (304) to be placed on interactive item E. When the pointer is removed from item E, the item is selected. In the present embodiment, the interactive item is then displayed over the full display for the user to interact therewith or observe it further. FIG. 3C shows interactive item E displayed over the full display (302) of the mobile phone (300) after it has been selected by removing the pointer from interactive object E in FIG. 3B. Once an item is selected, familiar actions such as swiping may be performed to advance or retreat to adjacently positioned items, zooming may be performed by placing two fingers on the touch-sensitive display and moving them apart or by double tapping. In some embodiments, share options are provided by which the interactive items may be shared via, for example, an email message, an instant message, social media, or the like.

The pointer (304) is, in FIG. 3D, positioned at a point on the control curve (314). Interactive item

A, the item presently allocated as the primary selectable item and appearing in the focus area (318), is then associated with this position on the control curve (314).

As shown in FIG. 3E, when the pointer is moved along the control curve, such as in the direction shown by the directional arrow (322), the interactive items (312) move along the display curve such that the primary selectable item is updated in the direction corresponding to the movement of the pointer (304). Interactive items are added to the display curve until the curve is filled with interactive items so that a maximum number of interactive items form part of the subset displayed in the display curve, in the present embodiment items A to W. The movement of the interactive items constitutes browsing. As the focus area (318) remains in a substantially static position on the display, the primary selectable item updates at a similar time as the subset of interactive items. In FIG. 3E, item O is shown as the primary selectable item.

When the pointer is moved even further, as shown by the directional arrow (322) in FIG. 3F, interactive items are removed from one end of the display curve at substantially the same time that an additional item is added at an opposite end of the display curve. In FIG. 3F, interactive items A to D have been removed at one end of the display curve, and interactive items X to AA have been added at the opposite end, with interactive item S shown as the primary selectable item in the focus area.

If the pointer is removed from the display at this stage, the items on the display curve remain in their current positions. If the pointer is placed on the display curve again, the current primary selectable item, presently S, will be allocated that position on the control curve. By using this method, traditional scrolling through a list of items may be simulated by continuously placing the pointer on the control curve, moving it, removing it, and continuing the action until the desired interactive item appears on the display curve where it may be selected.

In order to select the primary selectable item, a primary selection action is performed. In FIG. 3G, the pointer (314) is moved from its position in FIG. 3F, beyond the line (310) between the initial control region (306) and the display region (308) as indicated by the directional arrow (322). When the pointer remains stationary beyond the initial boundary for a predetermined amount of time, a selection indicator, in the present embodiment a thick border (324), appears around the primary selection item. When the pointer is removed from the screen whilst the selection indicator is present, the primary selection action is performed, and the primary selectable item, presently item S, is selected. The selected interactive item may then appear over the entire display similar to item E as was shown in FIG. 3C.

It should be noted that upon the pointer being placed in the initial control region, the control region is no longer limited in size such that it terminates at the line (310) between the initial control region (306) and the display region (308). After placement of the pointer in the initial control region, the control region expands to extend across the entire display. Therefore, when the pointer is moved over the initial border as shown in FIG. 3G, the movement and/or position thereof will still be projected onto the control curve. Browsing will thus still be possible when the pointer has been moved over the initial border, and the primary selectable item may still be changed. Limiting the extent of the control region until after the pointer has been placed therein may facilitate individual selection of all interactive items on the display curve before such placement. If the pointer is returned to within the original border, normal browsing may be performed, without the selection indicator appearing.

FIG. 3H shows the pointer (304) to be moved from the position shown in FIG. 3F, to within the continuous subset updating zone (320) at the end of the control curve. When within this zone, the subset of interactive items may be continuously updated, without the need to move the pointer further. In the present embodiment, the continuous subset updating zone is configured such that an initial updating rate matches the measured final browsing rate at the time of the pointer entering the continuous subset updating zone (320) from the control curve (314). If the pointer remains stationary within the zone, the subset will continue to update, along with the primary selectable item, until the end of the list of interactive items is reached. In order to stop the updating process, the pointer may be moved from the updating zone back onto the control curve. In some embodiments, a visual indication of the continuous subset updating zone is provided.

The updating rate can be altered by moving the pointer in a predetermined direction within the updating zone. Movement in one direction (326), in the present embodiment upwards on the display, decreases the updating rate, and movement in the opposite direction (328), in the present embodiment downwards on the display, increases the updating rate. In the present embodiment, the updating rate can only be reduced down to a minimum of zero, where the subset and primary selectable item remains stationary. However, in some embodiments, the updating zone may be configured such that there is a zero point where no updating occurs, and movement of the pointer through the zero point reverses the direction of updating. The location of the zero point will typically depend on the initial updating rate, with a high initial rate resulting in the zero point being further away from the point of entry into the updating zone (320) than a low initial rate.

It should be noted that the continuous subset updating zones (320) form part of the control region, and also extend past the line (310) between the initial control region (306) and the display region (308) after the pointer has been placed in the control region. Movement of the pointer from the extended control region into the continuous subset updating zone (320) is therefore also possible with the pointer beyond the line (310).

It should also be noted that the continuous subset updating zones (320) may be directly entered by the pointer, by placing the pointer in the updating zone without it having been placed on the control curve first.

If the pointer (304) is moved out of the continuous subset updating zone (320), updating of the subset of interactive items may occur as before, with the pointer on the control curve and described with reference to FIG. 3D to 3G. If the pointer is removed from the display when in the continuous subset updating zone, the subset of interactive items remain on the display curve as it was at the time the pointer is removed. Further browsing may then be initiated as described above.

The present embodiment also includes a zooming functionality. The control region of the present embodiment is configured such that movement of the pointer within the initial control region away from the line (310) decreases the size of the interactive items on the display curve. The focus area is similarly decreased. This is illustrated in FIG. 3I, and may be referred to as “zooming out”. Movement of the pointer (304) from the position in FIG. 3I is indicated by a directional arrow (322). In the present embodiment, once the interactive items have decreased to below a certain predetermined size, properties (330) of the current primary selectable item are displayed on the display. In this illustration, the creation date of the interactive item is displayed, although various other properties, such as title, particularly a first letter of the title, a description or the like may also be displayed. This may allow a user to more easily find interactive items in a large list of interactive items if they are familiar with the particular displayed property of the desired interactive item. The properties may be configured to gradually fade into view as the interactive items decrease in size. It should be noted that the current zoom level may be retained when the pointer enters the continuous subset updating zone, with continuous updating occurring at the same zoom level.

In some embodiments, the display curve terminates at its ends in vanishing points, with the items at the ends of the subset of interactive items appearing so small that they are barely, or not at all, recognizable. This may provide a user with a more aesthetically pleasing visual display.

The present method provides for hysteresis in movement of the pointer on the control curve and the scrolling region, in that relatively minor movements are disregarded or not taken into account in updating the primary currently selectable item. This allows for smoother browsing, scrolling, or transition between the browsing region and scrolling zones by ignoring movements due to an unsteady pointer. Additionally, the primary currently selectable item in the elliptical focus area (318) may be the subject of a so-called “focal dip”, which causes the primary currently selectable item to remain in the focus area for a longer period of time than if the selectable item had been updated linearly according to the movement of the pointer on the control curve or in the scrolling area. The focal dip effect causes a selectable item to appear to move faster on the edges of the focus area (318), when entering and exiting the focus area (318), and slower inside the focus area (318) when its centre coincides with the centre of the focus area (318). This may allow more certainty to a user as to the transition between selectable items, simplifying the selection of a desired interactive item.

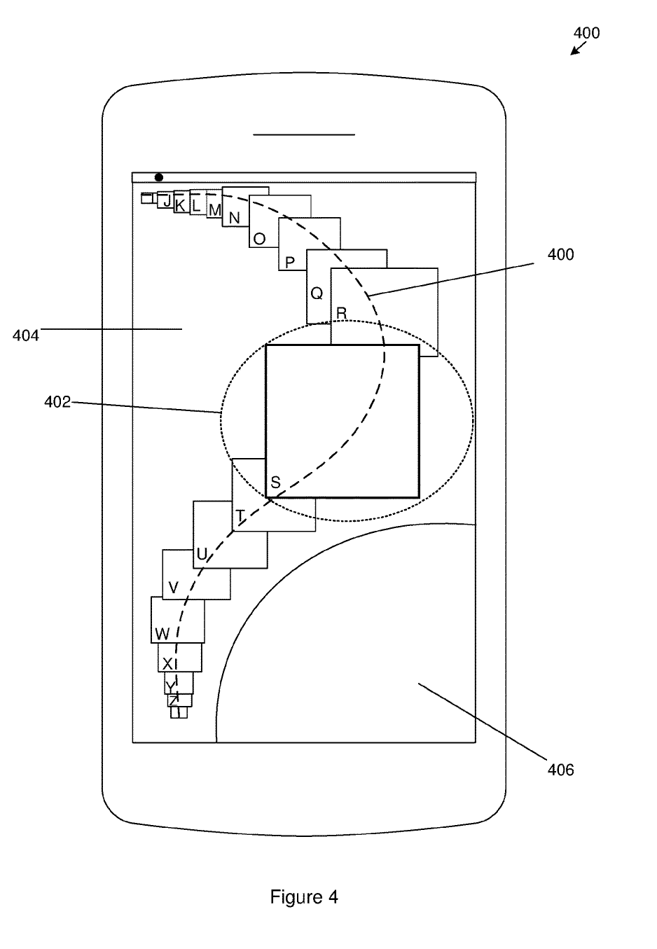

FIG. 4 illustrates an alternative implementation of a display and interaction method in a user interface, where a display curve (400) is provided that resembles the shape of a question mark. An elliptical focus area (402) is centrally located in a display area (404), and the primary selectable item (item S) is significantly larger than in the embodiment of FIG. 3.

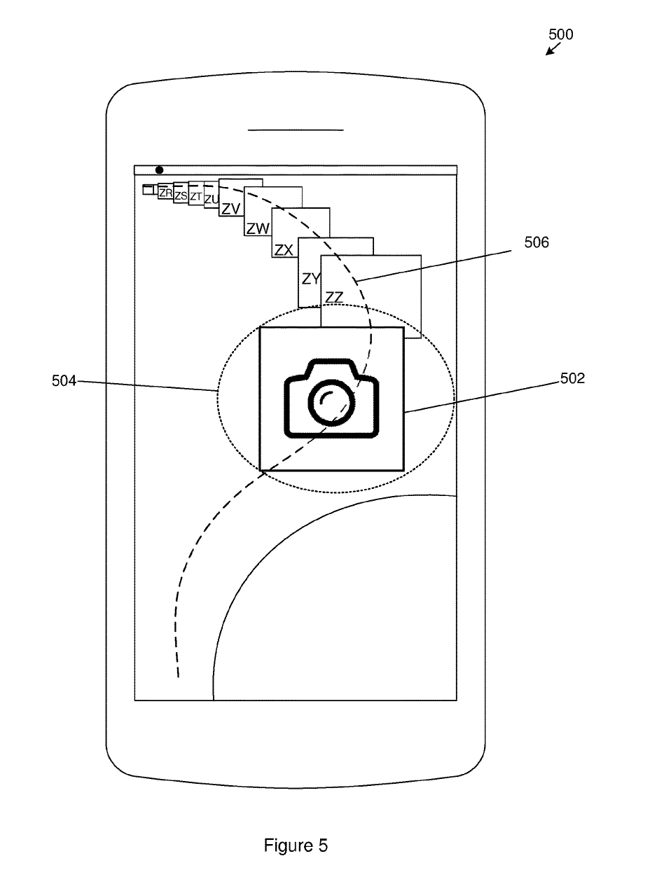

FIG. 5 shows a further embodiment of a display and interaction method in a user interface, wherein a selectable icon allowing an application to be launched is provided as part of the list of interactive items. In this embodiment, the list of interactive items are a list of photos stored on the electronic device, and the electronic device is a mobile phone (500) equipped with a camera. A camera icon (502) representing a camera application shortcut is inserted at the end of the list of interactive items. Once the final interactive item in the list, presently item ZZ, is moved through the primary selection region, the camera icon (502) is moved into the elliptical focus area (504), which also indicates the primary selection region. If the user performs a primary selection action on the camera icon, a camera application on the electronic device is launched, allowing the user to take a picture. It should be noted that the camera icon may function as a selectable interactive item so that it may also be selected by a selection action performed thereon when it is not in the primary selection region, but still appears on the display curve (506) as part of the subset of interactive items.

It should be noted that the camera icon may also be placed at the beginning of the list of interactive items, for example before item A, or at both ends of the list. It may also be positioned at multiple locations throughout the list of interactive items, for example at fixed intervals throughout the list. Furthermore, the camera icon may be configured to appear in response to a certain occurrence, for example that the pointer has remained stationary for a certain time period. Alternatively, the camera icon may remain in a substantially stationary location on the display region. Other icons, typically related to the interactive items, may also be provided in the list of interactive items, similar to the camera icon as explained above. For example, an icon that would launch a photo editing application could be provided. It is envisaged that selection of a photo editing icon in the list may launch the editing application with the primary selectable item. Any icon that may meaningfully respond to selection may be provided between the interactive items in the list. Additionally, any action which may be associated with the interactive items may be provided in the list of interactive items and displayed in the form of an icon, for example a delete action displayed as a trash can icon, or the like.

A display and interaction method is thus provided which may enable a user to effectively perform a visual search and selection operation. In embodiments of the invention the control region is separated from the display region. This may solve the finger occlusion problem as herein described. Furthermore, the use of a space-filling display curve mapped to a control curve may permit better utilisation of space in the display region.

The display and interaction method described herein may provide two-dimensional display resulting from one-dimensional control. In other words, movement along a substantially one-dimensional control curve may result in two-dimensional display changes in the display region.

In embodiments where the control curve is provided in a thumb zone of a user, the method and user interface may be particularly effective when the user only has one hand available to select an interactive item from a plurality of interactive items. For example, the method may be effective if one photo needs to be found in a set of 1000 photos or more on a mobile phone using only one hand.

It is foreseen that a complex display curve may be mapped to a relatively simple control curve, so as to allow a user to relatively easily navigate through a large number of interactive items in an intuitive manner.

The method and user interface of the present invention may provide greater efficiency in human-computer interaction. Conventional repetitions of “point and click”, repeatedly tapping, or time-consuming navigation of multiple menus and/or submenus may be significantly reduced or completely eliminated. Furthermore, the method and interface may allow for smoother and more dynamic human-computer interaction.

In some embodiments, the primary selection action may simply be that the user remove the pointer from the control region. This may be in response to the selection indicator appearing on the primary selectable item. In some embodiments, the selection indicator may not be required, and the primary selectable item may be selectable by performing the primary selection action. Similarly, a primary selection action may be performed when the pointer is removed from the continuous subset updating zone. In some embodiments, this may be in response to the pointer being moved to the zero point, and remaining there for a predetermined period of time. A selection indicator may appear to indicate to the user that lifting the pointer from the continuous subset updating zone will perform a selection action on the primary selectable item. When the primary selection action is the removal of the pointer from the control region at any time, a termination zone may be provided where a user may move the pointer to, and remove the pointer from that region. This may prevent unwanted selection of interactive items.

Different operation modes may also be provided, for example a standard mode and an advanced mode, the advanced mode including additional functionality over the standard mode. Such functionality may include, for example, a higher continuous subset updating speed, the possibility of reversing the updating direction in the continuous subset updating zone, and selection within the continuous subset updating zone.

In additional embodiments, the plurality of interactive items displayed on the display curve are a fixed set of interactive items forming a particular page. A number of pages may be provided, each page having a plurality of interactive items associated therewith and displayed on the display curve. In such a case, responsive to detecting a paging action performed by the pointer, the user interface may cause paging to be performed so as to display a different set of interactive items on the display curve forming a further page. Selection of interactive items on the display curve on each page may then be performed by directly selecting the desired interactive item.

The above description is by way of example only and it should be appreciated that numerous changes and modifications may be made to the embodiments described without departing from the scope of the invention.

The invention is not limited to embodiments in which the control region and display region are provided on a single touch-sensitive component such as a touch screen. The control curve and the display curve, and therefore the control region and the display region, need not be provided on the same device or region of a device. The control curve and the display curve may be provided on separate components of a single electronic device, such as on a keypad region and a screen of a laptop computer, respectively. Alternatively, the control curve and the display curve may be provided on physically separate electronic devices or components, such as on a remote control component and a screen component of a television, respectively.

Control and display may be separated by, for example, providing the control region on the remote control of a television and providing the display region on the screen of the television, or by providing the control region on a keypad portion of a smart watch device and providing the display region on the display of the smart watch device.

The actions described herein are primarily included for exemplary purposes and it should be understood that any suitable action may be employed. In some embodiments, the selecting action may involve moving the pointer out of the control curve without removing the pointer from contact with the control region.

It should be noted that the method of display and interaction provided involves continuous control and display, and not simply animation which is triggered by a distinct action from the user. Embodiments of the invention may, of course, incorporate animation into the user interface to, for example, provide for smoother transitions when interactive items are selected or when paging is performed.

The display curve and control curve may have any suitable shape or form to allow for different users or different devices. It is envisaged that the shape and/or form of the display curve and control curve may be user-adjustable. For example, the control curve may be horizontally provided on the display of an electronic device, and the display curve may overlap itself so as to reuse space in the display region, so as to even more effectively utilise display region space. In the embodiments described above, the control region was placed at a right-hand side of the mobile phone, and suitable for operation of a right thumb of a user. A person skilled in the art will realise that the control region may easily be mirrored such that operation with a left hand and thumb will be provided for. Furthermore, it should be noted that more than one control curve and/or display curve may be provided in some embodiments. Such control curves may be provided on separate devices. In an envisaged embodiment, a steering wheel of a motor vehicle will include two control curves, each one operable by a different thumb of a user, to allow the user to browse through lists with different hands. It is envisaged that the control curves may also be used to function in unison to allow for more efficient or complex browsing and/or scrolling functionality.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A display and interaction method in a user interface, comprising
providing a display region for displaying a subset of a plurality of interactive items on a display curve;
providing a touch-sensitive control region for hosting a control curve positioned separately from the display curve;
tracking the position and/or movement of a pointer in the control region; and
based on the position and/or movement of the pointer in the control region at a given time, updating the subset of the plurality of interactive items on the display curve.

2. A method as claimed in claim 1 which includes the step of projecting the position and/or movement of the pointer in the control region onto the control curve such that the position and/or movement in the control region is interpreted as the position and/or movement on the control curve.

3. A method as claimed in claim 1 wherein the display curve is provided in a touch-sensitive region of the user interface.

4. A method as claimed in claim 1 which includes the step of, responsive to detecting a selection action performed on any one of the interactive items on the display curve, selecting the interactive item.

5. A method as claimed in claim 4 wherein the selection action includes the pointer being placed on and removed from the desired interactive item on the display curve.

6. A method as claimed in claim 1 which includes the steps of: providing a primary selection region on the display curve; responsive to detecting a predefined change in the position and/or movement of the pointer on the control region, updating an interactive item within the primary selection region; and, responsive to detecting a selecting action for the primary selection region performed by the pointer, selecting the interactive item within the primary selection region.

7. A method as claimed in claim 6 wherein the selection action for the primary selection region includes removal of the pointer from contacting the touch-sensitive control region.

8. A method as claimed in claim 7 wherein the selection action for the primary selection region is performed in response to a selection indicator appearing at or near the interactive item within the primary selection region.

9. A method as claimed in claim 8 wherein the selection indicator appears at or near the interactive item in response to the pointer remaining stationary for a predetermined period of time, in response to the pointer remaining stationary for a predetermined period of time within the control region, or in response to the interactive item in the primary selection region having remained in the primary selection region for a predetermined period of time.

10. A method as claimed in claim 6 wherein the primary selection region is provided in a focus area, the focus area remaining in a substantially fixed position in the display region.

11. A method as claimed in claim 6 which includes the step of, in the display region, displaying properties of the interactive item in the primary selection region.

12. A method as claimed in claim 1 wherein the display curve and control curve are provided according to any of the manners selected from the list of: separately from each other on a single touch-sensitive display of an electronic device; on separate components of a single electronic device; and on physically separate electronic devices.

13. A method as claimed in claim 1 wherein the display curve is dynamically updated by contacting the control region with the pointer and moving the pointer along the control region so as to cause corresponding movement along the display curve, the movement constituting browsing through the interactive items.

14. A method as claimed in claim 1 which includes the step of displaying some of the interactive items in different sizes, and/or displaying some of the interactive items partially overlapping one another.

15. A method as claimed in claim 1 wherein the control curve is provided in a sector of the control region at a corner of the electronic device closest to a user's thumb when the electronic device is held in a palm of the user's hand.

16. A method as claimed in claim 1 wherein the control region is provided in a thumb zone of a touch-sensitive display of an electronic device, the thumb zone being a sector of the control region at a corner of the electronic device closest to a user's thumb when the electronic device is held in a palm of the user's hand, and the display curve is provided in a space-filling curve on the same display such that the interactive items displayed on the display curve substantially fill a remainder of the touch-sensitive display.

17. A method as claimed in claim 1 which includes the step of: providing a continuous subset updating zone at one or both ends of the control curve, with movement of the pointer into the continuous subset updating zone causing the plurality of interactive items on the display curve to be updated.

18. A method as claimed in claim 17 wherein the continuous subset updating zone is configured such that an initial updating rate matches a final browsing rate at the time of the pointer entering the continuous subset updating zone; and such that movement of the pointer in a predetermined direction within the continuous subset updating zone alters the updating rate and/or the updating direction.

19. A method as claimed in claim 17 wherein the continuous subset updating zone is configured such that a pointer can enter it without browsing on the control curve having occurred first.

20. A method as claimed in claim 1 which includes the step of: responsive to detecting a predefined change in position and/or movement of the pointer in relation to the control curve, dynamically updating a zoom level of at least one of the interactive items on the display curve.

21. A method as claimed in claim 1 which includes the step of: providing, as part of the list of interactive items, a selectable icon allowing an application to be launched or an action to be performed.

22. An electronic device having a user interface, the user interface comprising:
a display component for displaying a plurality of interactive items on a display curve;
a touch-sensitive control component for hosting a control curve positioned separately from the display curve;
a tracking component for tracking the position and/or movement of a pointer in the control region; and
an updating component for, responsive to detecting a position and/or movement of the pointer along the control curve, updating the interactive items on the display curve.

23. An electronic device as claimed in claim 22 which includes a projecting component for projecting the position and/or movement of the pointer in the control region onto the control curve such that the position and/or movement in the control region is interpreted as the position and/or movement along the control curve.

24. An electronic device as claimed in claim 22 which includes a selecting component for, responsive to detecting a selecting action performed on any one of the interactive items on the display curve, selecting the interactive item.

25. An electronic device as claimed in claim 22 which includes a continuous subset updating component for providing a continuous subset updating zone in the touch-sensitive control region wherein movement of the pointer into the continuous subset updating zone causes the plurality of interactive items on the display curve to be updated.

26. An electronic device as claimed in claim 22 which includes a zooming component for, responsive to detecting a predefined change in position and/or movement of the pointer in relation to the control curve, dynamically updating the zoom level of at least one of the interactive items on the display curve.
